(19) United States
(12) Patent Application Publication
(10) Pub. No.: US 2026/0311492 A1
(43) Pub. Date: Oct. 8, 2026

(54) DETECTING OCCLUSIONS IN IMAGES USING IMAGE SEGMENTATION

(71) Applicant: QUALCOMM Incorporated, San Diego, CA (US)

(72) Inventors: Hazem Ahmed Mohamed Mohamed RASHED, Kronach (DE); Kiran BANGALORE RAVI, Paris (FR); Sourab BAPU SRIDHAR, Danderyd (SE); Varun RAVI KUMAR, San Diego, CA (US); Senthil Kumar YOGAMANI, San Diego, CA (US)

(21) Appl. No.: 19/169,767

(22) Filed: Apr. 3, 2025

(51) Int. Cl. G06V 20/58; B60W 30/08; G06V 10/26

(52) U.S. Cl. CPC G06V 20/58; B60W 30/08; G06V 10/26; G06V 2201/07

(57) ABSTRACT

Systems and techniques are described herein for detecting occlusions. For instance, a method for detecting occlusions is provided. The method may include detecting an object in an image; determining a bounding box based on the object in the image; determining an image patch of the image based on the bounding box; segmenting the image patch into a plurality of segments; and determining that the object is at least partially occluded in the image based on the bounding box and the plurality of segments.

### TECHNICAL FIELD

The present disclosure generally relates to imaging. For example, aspects of the present disclosure include systems and techniques for detecting occlusions in images.

### BACKGROUND

Occlusion detection and/or visibility detection refer to techniques to detect which regions of an image are occlusion boundaries and/or which regions of an image represent objects occluded by other objects. Visibility detection, occlusion detection, and/or occlusion reasoning includes the detection of whether a prediction (e.g., a bounding box based on a detected object) from perception stack (e.g., an object detector) is being occluded or blocked by another detected object or an unknown object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for detecting occlusions. According to at least one example, a method is provided for detecting occlusions. The method includes: detecting an object in an image; determining a bounding box based on the object in the image; determining an image patch of the image based on the bounding box; segmenting the image patch into a plurality of segments; and determining that the object is at least partially occluded in the image based on the bounding box and the plurality of segments.

In another example, an apparatus for detecting occlusions is provided that includes at least one memory and at least one processor (e.g., configured in circuitry) coupled to the at least one memory. The at least one processor configured to: detect an object in an image; determine a bounding box based on the object in the image; determine an image patch of the image based on the bounding box; segment the image patch into a plurality of segments; and determine that the object is at least partially occluded in the image based on the bounding box and the plurality of segments.

In another example, a non-transitory computer-readable medium is provided that has stored thereon instructions that, when executed by one or more processors, cause the one or more processors to: detect an object in an image; determine a bounding box based on the object in the image; determine an image patch of the image based on the bounding box; segment the image patch into a plurality of segments; and determine that the object is at least partially occluded in the image based on the bounding box and the plurality of segments.

In another example, an apparatus for detecting occlusions is provided. The apparatus includes: means for detecting an object in an image; means for determining a bounding box based on the object in the image; means for determining an image patch of the image based on the bounding box; means for segmenting the image patch into a plurality of segments; and means for determining that the object is at least partially occluded in the image based on the bounding box and the plurality of segments.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system for determining degrees of occlusion of objects in images, according to various aspects of the present disclosure;

FIG. 2 is a block diagram illustrating an example system for determining a degree of occlusion (e.g., occlusion determination) of an object in image, according to various aspects of the present disclosure;

FIG. 3 includes an example image overlaid with a bounding box determined based on an object in the image;

FIG. 4 includes an image and an image overlaid with visual representations of segments;

FIG. 5 is a block diagram of an example system for determining occlusions based on image patches, according to various aspects of the present disclosure;

FIG. 6 includes an example image including masked portions, according to various aspects of the present disclosure;

FIG. 7 is a flow diagram illustrating an example process for detecting occlusions, in accordance with aspects of the present disclosure;

FIG. 8 is a block diagram illustrating an example of a deep learning neural network that can be used to perform various tasks, according to some aspects of the disclosed technology;

FIG. 9 is a block diagram illustrating an example of a convolutional neural network (CNN), according to various aspects of the present disclosure; and

FIG. 10 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Occlusion detection, visibility detection, and/or occlusion reasoning refer to techniques to determine which regions of sensor data (e.g., an image) represent objects occluded by other objects and/or which regions of the sensor data are occlusion boundaries. Occlusion detection, visibility detection, and/or occlusion reasoning include the detection of whether a prediction (e.g., a bounding box based of a detected object) from a perception stack (e.g., an object detector) is being occluded or blocked by another detected object or an unknown object. An auxiliary problem is to determine a degree of occlusion (e.g., a percentage of occlusion).

Object detectors may be used for various perception tasks. For example, object detectors may be used to detect vehicles, pedestrians, cyclists, traffic lights, traffic signs, lane lines, etc. in images. There may be detector trained specifically to detect a class of object, for example, there may be a vehicle detector and separately a pedestrian detector.

Occlusion detection, visibility detection, and/or occlusion reasoning may be used on outputs from any suitable object detector, such as any type of two-dimensional (2D) or three-dimensional (3D) object detector. For example, a traffic-light detector, a traffic-sign detector, and a lane detector (among others) may detect objects. The detected objects may be analyzed by occlusion detection, visibility detection, and/or occlusion reasoning to determine a degree of occlusion of the detected objects.

Occlusion detection may be important in evaluating the performance and robustness of object detectors. For example, in evaluating the performance of an object detector in detecting an object in an image, it may be important to know to what degree the object is occluded in the image.

Further, to train an object detector to be robust to occlusions, it may be valuable to train such an object detector using images with objects occluded varying degrees of occlusion. Accordingly, it may be valuable to be able to evaluate a corpus of training data to determine whether images of the corpus of training data include occluded objects and to what degree the objects are occluded in the various images. Additionally or alternatively, when training an object detector, to determine errors (e.g., when predictions of an object detector do not match the ground truth), it may be valuable to be able to correlate the error with a degree of occlusions of the objects in the images.

Conventional algorithms for occlusion detection may use point clouds and their aggregation. Such conventional algorithms and usually work by performing ray tracing in the point cloud.

Using point clouds may be computationally expensive. Further, point-cloud data may be more difficult to obtain than image data.

Systems, apparatuses, methods (also referred to as processes), and computer-readable media (collectively referred to herein as “systems and techniques”) are described herein for occlusion detection. For example, the systems and techniques described herein may determine a degree to which an object is occluded in an image.

The systems and techniques may evaluate occlusion in images. The evaluations may be used for monocular two-dimensional (2D) or three-dimensional (3D) object detectors. The object detectors may be trained to be occlusion agonistic. The systems and techniques may evaluate occlusions using image data (e.g., without the use of external 3D sensors or high definition (HD) map information).

Occlusion detection may be important in evaluating the performance and robustness of object detectors. For example, in evaluating the performance of an object detector in detecting an object in an image, it may be important to know to what degree the object was occluded in the image.

Further, to train an object detector to be robust to occlusions, it may be valuable to train such an object detector using images with varying degrees of occlusions. Additionally or alternatively, to determine errors (e.g., when predictions of an object detector do not match the ground truth) when training an object detector, it may be valuable to be able to correlate the error with a degree of occlusions of the objects in the images.

In the present disclosure, various examples include vehicles and images captured by cameras positioned on vehicles. However, the systems and techniques are not limited to vehicle applications and can be applied to any other systems or applications, such as extended reality (XR) systems or applications, robotic systems or applications, among others.

Various aspects of the application will be described with respect to the figures below.

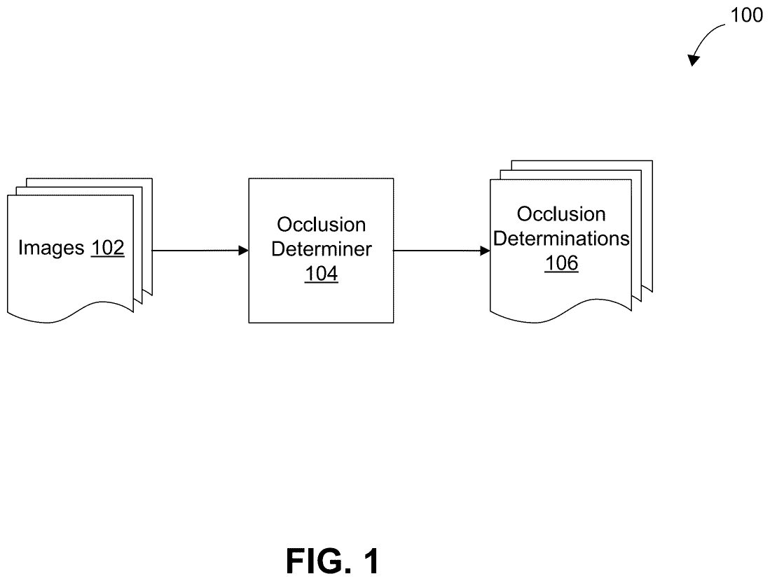

FIG. 1 is a block diagram illustrating an example system 100 for determining degrees of occlusion of objects in images 102, according to various aspects of the present disclosure. In general, occlusion determiner 104 may obtain images 102 and generate instances of occlusion determinations 106 based on each of images 102. In some aspects, occlusion determiner 104 may annotate or label images 102 (e.g., in metadata) with occlusion determinations 106. For example, occlusion determiner 104 may detect objects in images 102, and determine a degree of occlusion of the detected objects in images 102.

Images 102 and occlusion determinations 106 may be used as training data or evaluation data to train or evaluate an object detector. For example, the object detector may be tasked with detecting objects in images 102. The object detector may be evaluated based on how well the object detector detected objects. The object detector may be evaluate differently based on how well the object detector detected occluded objects as compared to how well the object detector detected unoccluded objects.

As another example, training data may be selected to train an object detector based on occlusions within the training data. For example, images may be selected from among images 102 based on occlusion determinations 106 such that the selected images include a particular ratio of occluded and unoccluded objects.

As yet another example, an object detector may be trained using images 102. Parameters (e.g., weights) of the object detector may be adjusted differently based on a degree of occlusion of objects in images 102. For example, the parameters may be adjusted to a greater degree if the object detector failed to detect an unoccluded object than if the object detector failed to detect a mostly occluded object.

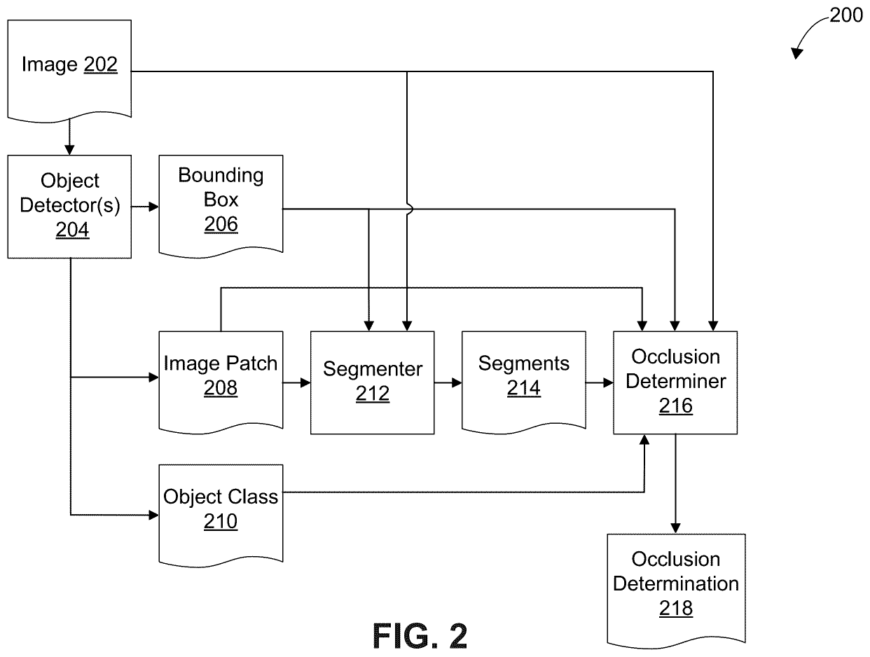

FIG. 2 is a block diagram illustrating an example system 200 for determining a degree of occlusion (e.g., occlusion determination 218) of an object in image 202, according to various aspects of the present disclosure. System 200 may be an example of occlusion determiner 104 of FIG. 1.

Image 202 may be a two-dimensional (2D) image of a scene. The scene may include objects. The image may include a 2D representation of the scene including respective representations of the objects. By way of example, image 202 may be captured by a camera of a vehicle. As other examples, image 202 may be captured by an extended-reality (XR) systems (which may include virtual-reality (VR) systems, augmented-reality (AR) systems, and/or mixed-reality (MR) systems), by a robot, by a stationary camera (e.g., a security camera), by a personal computing device, etc.

Object detector(s) 204 may include one or more object detectors. The object detectors may be, or may include, machine-learning models trained (e.g., through an iterative backpropagation process) to detect objects in images.

In some aspects, object detector(s) 204 may include one object detector configured to detect multiple classes of objects, such as vehicles, pedestrians, cyclists, traffic lights, traffic signs, lane lines, etc. In other aspects, object detector(s) 204 may include object detectors for multiple respective classes, such as a vehicle detector, a pedestrian detector, a cyclist detector, a traffic-light detector, a traffic-sign detector, a lane-line detector, etc.

Object detector(s) 204 may generate bounding boxes for each object detected in object detector(s) 204. Bounding box 206 is given as an example of such bounding boxes. Bounding box 206 may be a bounding box of one object detected by object detector(s) 204 in image 202. Bounding box 206 may include pixel coordinates of a rectangle of pixel data of image 202 that relates to object. For example, bounding box 206 may describe a rectangle of pixels that represent the object. In some cases, bounding box 206 may be the smallest rectangle that completely represents the object.

In some aspects, object detector(s) 204 may additionally generate an image patch 208 based on bounding box 206. In other aspects, system 200 may generate image patch 208 based on bounding box 206. Image patch 208 may include pixels of bounding box 206 and additional pixels beyond the boundaries of bounding box 206.

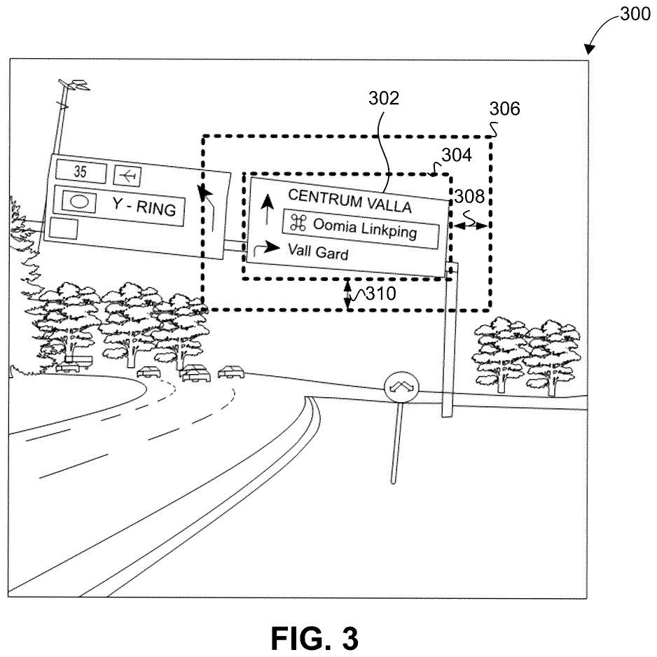

As an example, FIG. 3 includes an example image 300 overlaid with bounding box 304 determined based on object 302 in image 300. As an example, bounding box 304 includes the smallest rectangle of pixels that represent object 302 in image 300. Image patch 306 includes bounding box 304 and additional pixels around bounding box 304. For example, image patch 306 is extended beyond bounding box 304 in all directions by a margin (e.g., by a horizontal margin 308 and a vertical margin 310 that may or may not have the same magnitude).

Returning to FIG. 2, in some aspects, object detector(s) 204 may generate an indication of a class of the detected object (e.g., object class 210). In some aspects, object class 210 may be tied to the type of classifier of object detector(s) 204 that detected the object. For example, a pedestrian detector may detect pedestrians. In such cases, object class 210 may be implicit rather than a specific data product output by object detector(s) 204. For example, downstream users of object class 210 (e.g., occlusion determiner 216) may infer object class 210 based on a detector that generated bounding box 206.

Segmenter 212 may identify segments 214 of image patch 208. Segments 214 may include polygons made up of pixels of image patch 208. Segmenter 212 may generate segments 214 such that different segments of segments 214 indicate pixels of image patch 208 that represent different objects.

Segmenter 212 may be, or may include, a machine-learning model trained to segment images. As an example, segmenter 212 may be, or may include, a Segment Anything Model (SAM).

In some aspects, segmenter 212 may generate segments 214 based on image patch 208. For example, system 200 (or object detector(s) 204) may generate image patch 208 and provide image patch 208 to segmenter 212 and segmenter 212 may generate segments 214 based on image patch 208. In other aspects, segmenter 212 may obtain image 202 and bounding box 206 and generate segments 214 by segmenting image 202 around bounding box 206 or by generating image patch 208 based on bounding box 206, then generating segments 214 based on image patch 208.

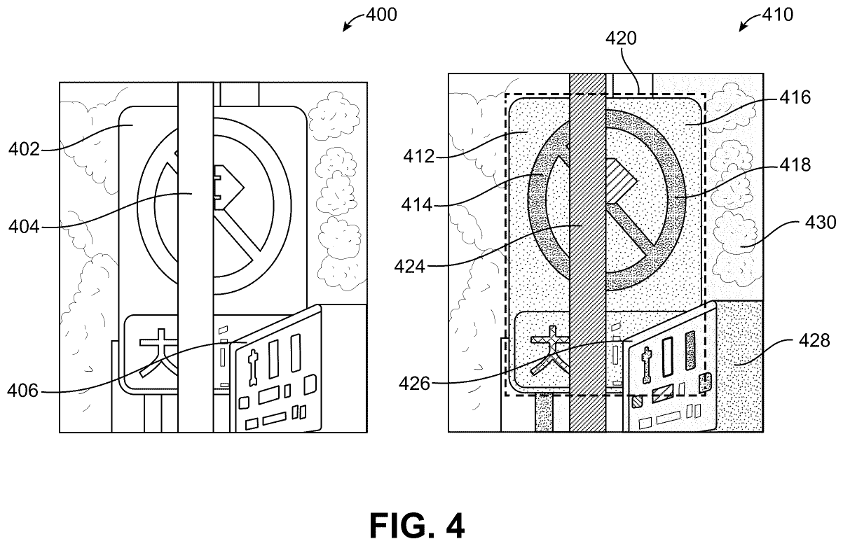

As an example, FIG. 4 includes an image 400 and an image 410 overlaid with visual representations of segments. Image 400 may be an example of image patch 208. Image 400 includes pixels representative of various objects (e.g., object 402, object 404, and object 406). According to the example of FIG. 4, object 402 may be a detected object (e.g., detected by object detector(s) 204). Object 404 and object 406 may occlude object 402 in image 400.

Segmenter 212 may segment image 400 to generate segments 214 including indications of pixels of image 400 that relate to separate objects. For example, image 410 is overlaid with visual representations of segments, with various patterns relating to various segments. Segment 414 may be represented as various masks, for example, masking pixels of image 400.

For example, segmenter 212 may identify pixels representative of object 402 as segment 412, segment 414, segment 416, and segment 418. In some cases, segment 412 and segment 416 may be a single or related segment. For example, segment 412 and segment 416 may share a segment identifier. Additionally or alternatively, segment 414 and segment 418 may share a segment identifier with (or be related to) segment 416 and/or segment 416. Further, segmenter 212 may identify pixels representative of object 404 as segment 424 and pixels representative of object 406 as segment 426.

Returning to FIG. 2, occlusion determiner 216 may determine occlusion determination 218 based on segments 214 and bounding box 206. Occlusion determination 218 may include an indication of a degree of occlusion of the object detected by object detector(s) 204 (e.g., the object on which bounding box 206 is based).

In some aspects, occlusion determination 218 may include a binary indication, for example, indicating whether the object is occluded or not. In other aspects, occlusion determination 218 may include an indication of a degree of occlusion, for example, indicating that object 402 is 20% occluded in image 400. In other aspects, occlusion determination 218 may include a characterization of occlusion, for example, indicating that object 402 is “partially occluded” in image 400. In some aspects, occlusion determiner 216 may determine occlusion determination 218 based, at least in part, on object class 210. For example, occlusion determiner 216 may determine occlusion determination 218 according to class-based thresholds. For example, if 20% of a sign is occluded, occlusion determiner 216 may determine that the sign is “partially occluded.” However, if 20% of a vehicle is occluded, occlusion determiner 216 may determine that the vehicle is “unoccluded” or “substantially unoccluded.”

Occlusion determiner 216 may use one or more approaches to determine occlusion determination 218 based on segments 214 and bounding box 206. In some aspects, occlusion determiner 216 may determine occlusion determination 218 by using outputs from the multiple approaches in a winner-takes-all approach (e.g., selecting occlusion determination 218 based on the highest degree of occlusion determined by any of the methods). In other aspects, occlusion determiner 216 may determine occlusion determination 218 based on an average or weighted average of outputs from the multiple approaches.

According to a first approach, occlusion determiner 216 may determine a bounding-box-fill ratio and determine a degree of occlusion based on the bounding-box-fill ratio. Using image 410 of FIG. 4 as an example, bounding box 420 (e.g., an indication of an object 402) may be an example of bounding box 206. Occlusion determiner 216 may determine that segment 412, segment 414, segment 416, segment 418, relate to object 402. Occlusion determiner 216 may determine a relationship (e.g., a ratio) between the combined area of segment 412, segment 414, segment 416 and segment 418 and the area of bounding box 420. Occlusion determiner 216 may determine the degree of occlusion of object 402 based on the relationship. For example, if the combined area of segment 412, segment 414, segment 416, and segment 418 is 80% of the area of bounding box 420, occlusion determiner 216 may determine that object 402 is 20% occluded. As another example, if the combined area of segment 412, segment 414, segment 416, and segment 418 is smaller than the area of bounding box 420 by a factor that is less than a first threshold and greater than a second threshold, occlusion determiner 216 may determine that object 402 is “partially occluded.” In some aspects, such thresholds may be class dependent. For example, if 20% of a sign is occluded, occlusion determiner 216 may determine that the sign is “partially occluded.” However, if 20% of a vehicle is occluded, occlusion determiner 216 may determine that the vehicle is “unoccluded” or “substantially unoccluded.”

According to the first approach, if bounding box 420 is determined based on object 402, then the combined area of segments that correspond to object 402 should fill bounding box 420. However, if there are objects occluding object 402 (e.g., object 404 and object 406), the segments based on those objects (e.g., segment 424 and segment 426) will decrease the ratio between the combined area of the segments representing object 402 and the area of bounding box 420. Accordingly, a ratio of the area of segments representing object 402 (e.g., object segments, such as segment 412, segment 414, segment 416, and segment 418) and the area of bounding box 420 may indicate a degree of occlusion of object 402.

A second approach to determining a degree of occlusion is based on identifying occluding segments (e.g., segments of pixels that represent objects that occlude an object). For example, occlusion determiner 216 may determine whether an occluding segment intersects with a boundary of a bounding box. For example, occlusion determiner 216 may determine that segment 424 is an occluding segment based on segment 424 intersecting with bounding box 420.

As another example, of the second approach, occlusion determiner 216 may identify segments that have portions inside a bounding box and outside the bounding box. For example, occlusion determiner 216 may identify segment 424 as an occluding segment based on segment 424 including a portion inside bounding box 420 and two portions outside bounding box 420. Similarly, occlusion determiner 216 may identify segment 426 as an occluding segment based on segment 426 including a portion inside object 402 and a portion outside bounding box 420.

For example, for each detected object (e.g., for each object detected by object detector(s) 204), occlusion determiner 216 may identify all masks (e.g., segments of segments 214) with non-zero intersection with the detected object (e.g., no intersection with bounding box 206). For instance, occlusion determiner 216 may identify segments that overlap with bounding box 420. For example, occlusion determiner 216 may identify segment 412, segment 414, segment 416, segment 418, segment 424, segment 426, as having portions overlapping with bounding box 420. In contrast, segment 428 and segment 430 do not overlap with bounding box 420.

Additionally, occlusion determiner 216 may evaluate a mask-box overlap (MBO). The MBO may be defined as the area of a mask divided by the area of the mask within the bounding box. For example, the MBO of segment 424 may be the total area of segment 424 divided by the area of the portion of segment 424 that overlaps with bounding box 420. Mask (e.g., segments) that are within the detection (e.g., masks within bounding box 420, such as segment 412, segment 414, segment 416, segment 418), the MBO will be substantially equal to 1 (e.g., indicating that 100% of the segment is withing the bounding box). Such segments may represent the detected object.

Masks extending across the detection (e.g., segments with portions inside and outside bounding box 420), the MBO will be less than 1 since the masks include portions outside bounding box 420. Such segments may represent occluding objects (e.g., objects that are between a camera and the detected object). For example, segment 424 and segment 426 may have an MBO between 0 and 1 (e.g., indicating that a portion of each of segment 424 and segment 426 is within bounding box 420 and that a portion of each of segment 424 and segment 426 is outside bounding box 420).

Masks that are entirely without the detection (e.g., segments without portions inside bounding box 420, such as segment 428 and segment 430), the MBO will be zero. Such segments may be objects that do not occlude the object.

Occlusion determiner 216 may determine occlusion determination 218 based on occluding segments. In some cases, occlusion determiner 216 may determine occlusion determination 218 based on whether there are any occluding segments. In some cases, occlusion determiner 216 may determine occlusion determination 218 based on a count of, areas of, and/or a MBOs of occluding segments.

A third approach to determining a degree of occlusion is based on features representing an image or image patches. For example, the third approach may involve using an image encoder that generates semantic features based on images. The third approach may involve generating semantic features based on an image patch and semantic features based on the image patch with occluding objects removed. The third approach may involve comparing the semantic features to determine how much the features changed based on removing the occluding objects. If the occluding objects did not change the features much, the occlusion of the object may not be severe (for example, the object is still semantically recognizable as substantially the same even with the occlusion). If the occluding objects changed the features significantly, the occluding of the object may have been severe (for example, the object is not semantically the same based on the occlusion).

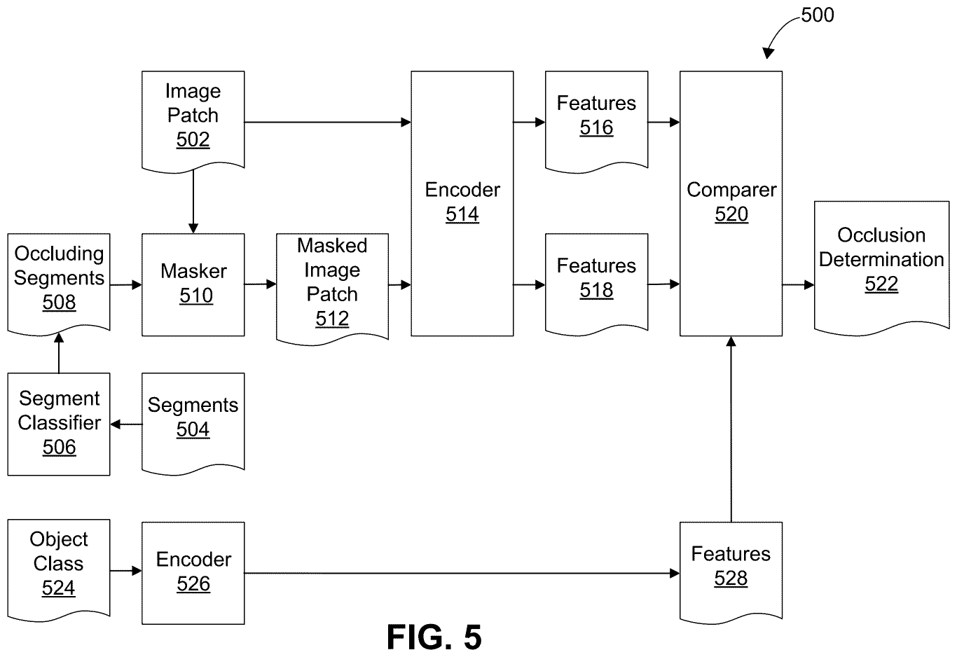

FIG. 5 is a block diagram of an example system 500 for determining occlusions based on image patches, according to various aspects of the present disclosure. System 500 may be implemented by occlusion determiner 216 of FIG. 2. For example, image patch 502 may be an example of image patch 208 of FIG. 2. Segments 504 may be an example of segments 214 of FIG. 2.

Segment classifier 506 may classify segments of segments 504 as, for example, object segments, occluding segments (e.g., occluding segments 508), or other segments. For example, segment classifier 506 may classify segments that relate to an object (e.g., object 402) for example, by being within a bounding box based on the object (e.g., bounding box 420) as object segments. For instance, segment classifier 506 may classify segment 412, segment 414, segment 416, and segment 418 as object segments based on segment 412, segment 414, segment 416, and segment 418 being entirely within bounding box 420.

Further, segment classifier 506 may classify segments that have portions both within and without the bounding box as occluding segments (e.g., occluding segments 508). For instance, segment classifier 506 may classify segment 424 and segment 426 as occluding segments based on segment 424 and segment 426 including portions within bounding box 420 and portions without bounding box 420.

Segment classifier 506 may classify other segments (e.g., segments that are not object segments and segments that are not occluding segments) as “other” or “irrelevant.” Other segments may not have any portion within the bounding box (e.g., bounding box 420).

Masker 510 may mask occluding segments 508 of image patch 502. For example, masker 510 may set pixel values of occluding segments 508 in image patch 502 as 0 or 255 to generate masked image patch 512. As such, masked image patch 512 may be image patch 502 with occluding segments 508 removed (or set to white or black).

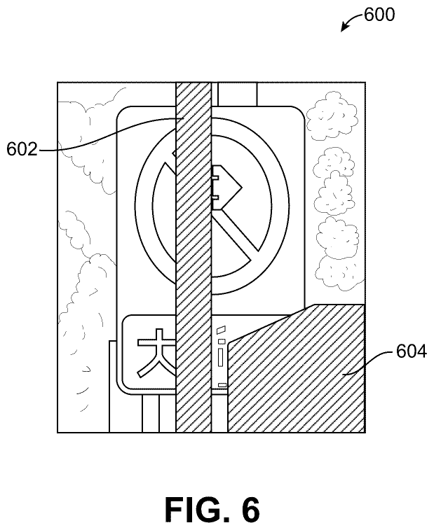

For example, FIG. 6 includes an example image 600 including masked portions (masked portion 602 and masked portion 604), according to various aspects of the present disclosure. Image 600 may be image 410 with segment 424 and segment 426 masked (e.g., with pixel values corresponding to segment 424 and segment 426 set to zero).

Encoder 514 may encode image patch 502 to generate features 516. Further, encoder 514 may encode masked image patch 512 to generate features 518. Encoder 514 may include one encoder, used once for image patch 502 and once for masked image patch 512. Alternatively, encoder 514 may include two instances of the same encoder, for example, used once to encode image patch 502 and once to encode masked image patch 512.

Encoder 514 may be, or may include, a machine-learning model trained to generate semantic features based on images. For example, encoder 514 may be an image encoder of a Contrastive Language-Image Pretraining (CLIP) encoder. For instance, encoder 514 may be trained to encode images and features alongside a text encoder that may be trained to encoder text related to the images as features. Encoder 514 and the text encoder may have been trained to generate similar features based on corresponding pairs of images and text.

In some aspects, comparer 520 may compare features 516 to features 518 and determine occlusion determination 522 based on the comparison. For example, comparer 520 may determine an L2 distance between features 516 (which may be an N-dimensional vector) and features 518 (which may also be an N-dimensional vector). Comparer 520 may determine occlusion determination 522 based on the determined distance.

In some aspects, system 500 may obtain object class 524. Object class 524 may be an example of object class 210. Object class 524 may include text describing an object on which image patch 502 is based.

Encoder 526 may encode object class 524 to generate features 528. Encoder 526 may be, or may include, a text encoder of a CLIP encoder (e.g., the CLIP encoder of encoder 514). As such, encoder 526 may be trained to process input text relating to an input image and generate features that are substantially similar to features generated by an image encoder processing the input image.

In some aspects, comparer 520 may compare features 516 to features 528 and determine a first result (e.g., based on a distance between features 516 and features 528). Comparer 520 may further compare features 518 to features 528 determine a second result (e.g., based on a distance between features 518 and features 528). Comparer 520 may compare the first result and the second result and determine occlusion determination 522 based on the comparison.

According to such a comparison, a distance between features 528 and features 516 may indicate how recognizable the object of image patch 502 is in image patch 502. Similarly, a distance between features 528 and features 518 may indicate how recognizable the object of masked image patch 512 is in masked image patch 512. The comparison of the distances may reveal how much less recognizable the object is with the occlusions removed.

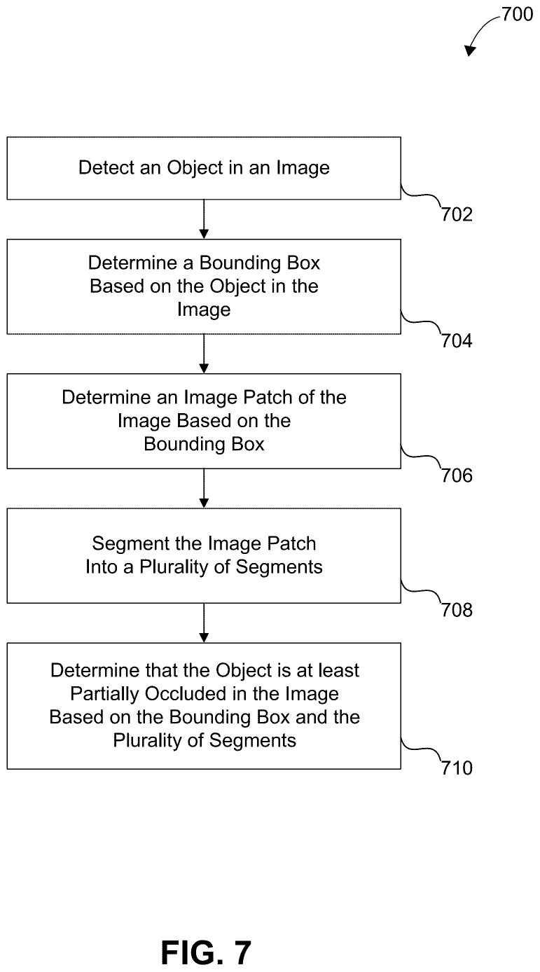

FIG. 7 is a flow diagram illustrating an example process 700 for determining occlusions, in accordance with aspects of the present disclosure. One or more operations of process 700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 700. The one or more operations of process 700 may be implemented as software components that are executed and run on one or more processors.

At block 702, a computing device (or one or more components thereof) may detect an object in an image. For example, detector(s) 204 may detect an object in image 202.

At block 704, the computing device (or one or more components thereof) may determine a bounding box based on the object in the image. For example, detector(s) 204 may determine bounding box 206 based on the object detected at block 702.

At block 706, the computing device (or one or more components thereof) may determine an image patch of the image based on the bounding box. For example, detector(s) 204 may determine image patch 208 based on bounding box 206.

At block 708, the computing device (or one or more components thereof) may segment the image patch into a plurality of segments. For example, segmenter 212 may segment image patch 208 to generate segments 214.

At block 710, the computing device (or one or more components thereof) may determine that the object is at least partially occluded in the image based on the bounding box and the plurality of segments. For example, occlusion determiner 216 may determine that the object detected at block 702 is at least partially occlude based on bounding box 206 and segments 214.

In some aspects, the computing device (or one or more components thereof) may identify at least one object segment from among the plurality of segments. The at least one object segment may relate to the object detected in the image. The determination that the object is at least partially occluded in the image is based on a relationship between an area of the at least one object segment and an area of the bounding box. For example, occlusion determiner 216 may identify at least one object segment from among segments 214. The object segment may indicate pixels that represent the object detected at block 702. Occlusion determiner 216 may determine that the object is partially occluded in image 202 based on a ratio between the area of bounding box 206 and the area of the at least one object segment. For example, occlusion determiner 216 may determine whether object 402 is partially occlude in image 410 based on a ratio of the area of segments representing object 402 (e.g., object segments, such as segment 412, segment 414, segment 416, and segment 418) and the area of bounding box 420.

In some aspects, the computing device (or one or more components thereof) may classify the object to obtain an object class; determine a threshold based on the object class; and determine that the object is at least partially occluded in the image based on a value associated with a comparison between the area of the at least one object segment and the area of the bounding box being below the threshold. For example, detector(s) 204 may classify the object detected at block 702 to determine an object class. Occlusion determiner 216 may determine a threshold based on the object class. Further, occlusion determiner 216 may determine whether the object detected at block 702 is occlude based on the area of the at least on object segment, the area of the bounding box, and the threshold. For example, if the object detected at block 702 is a vehicle, the ratio may be 50%, such that if the area of object segments (e.g., the segments that represent the vehicle) fill less than 50% of the bounding box, occlusion determiner 216 may determine that the object is occluded. As another example, if the object detected at block 702 is a traffic sign, the ratio may be 75%, such that if the area of object segments (e.g., the segments that represent the vehicle) fill less than 75% of the bounding box, occlusion determiner 216 may determine that the object is occluded.

In some aspects, the computing device (or one or more components thereof) may identify at least one occluding segment from among the plurality of segments. The at least one occluding segment may relate to an object that occludes a view of the object detected in the image. The determination that the object is at least partially occluded in the image may be based on the at least one occluding segment and the bounding box. For example, occlusion determiner 216 may identify at least one occluding segment from among segments 214. The occluding segments may represent objects that occlude a view of the object detected at block 702 in image 202. For example, occlusion determiner 216 may identify segment 424 and segment 426 as occluding segments. Occlusion determiner 216 may determine whether object 402 is at least partially occluded in image 410 based on segment 424 and segment 426.

In some aspects, an occluding segment of the at least one occluding segment may be identified based on a determination that a portion of the occluding segment intersects at least one boundary of the bounding box. For example, occlusion determiner 216 may determine that segment 424 and segment 426 intersect a boundary of bounding box 420.

In some aspects, the computing device (or one or more components thereof) may process the image patch using an image encoder to generate first image features; identify at least one occluding segment from among the plurality of segments; mask the at least one occluding segment in the image patch to generate a masked image patch; and process the masked image patch using the image encoder to generate second image features; wherein the determination that the object is at least partially occluded in the image is based on a comparison between the first image features and the second image features. For example, encoder 514 may generate features 516 based on image patch 502. Segment classifier 506 may determine occluding segments 508 based on segments 504. Masker 510 may mask segments 508 in image patch 502 to generate masked image patch 512. Encoder 514 may process masked image patch 512 to generate features 518. Comparer 520 may compare features 516 to features 518 to determine whether the object is at least partially occluded.

In some aspects, the computing device (or one or more components thereof) may classify the object to obtain an object class; and process the object class using an encoder to generate class features; wherein the determination that the object is at least partially occluded in the image is based on the class features, the first image features and the second image features. For example, the object may be classified (e.g., by a classifier or object detector). Encoder 526 may generate features 528 based on object class 524. Comparer 520 may determine whether the object is at least partially occluded in the image based on features 516, features 518 and features 528.

In some aspects, the computing device (or one or more components thereof) may be, or may be included in, a computing system of a vehicle. In some aspects, the computing device (or one or more components thereof) may adjust an operating parameter of the vehicle based on the determination that the object is at least partially occluded. In some aspects, the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the determination that the object is at least partially occluded using a user interface of the vehicle.

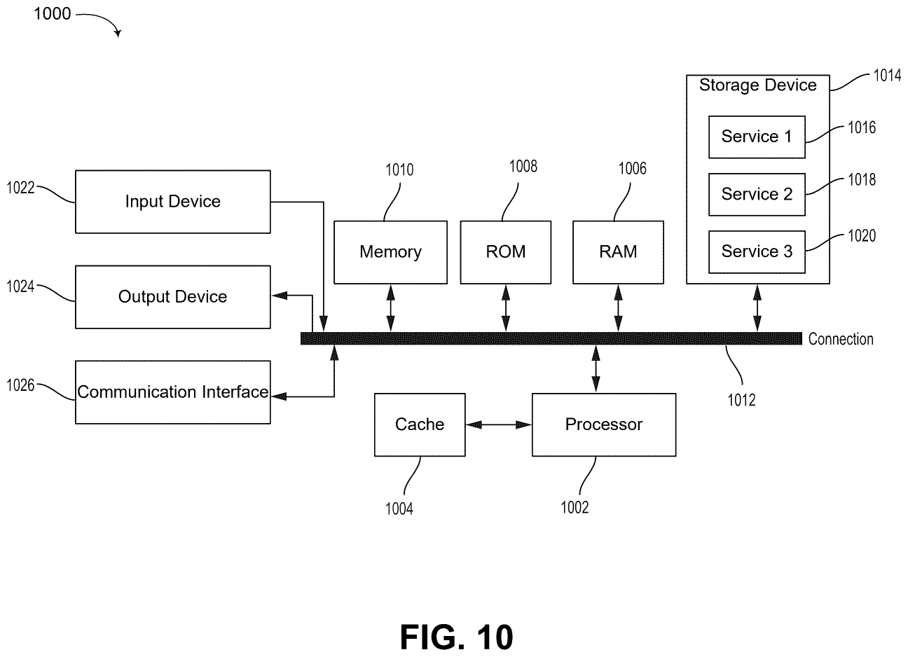

In some examples, as noted previously, the methods described herein (e.g., process 700 of FIG. 7, and/or other methods described herein) can be performed, in whole or in part, by a computing device or apparatus. In one example, one or more of the methods can be performed by occlusion determiner 104 of FIG. 1, system 200 of FIG. 2, and/or system 500 of FIG. 5, or by another system or device. In another example, one or more of the methods (e.g., process 700, and/or other methods described herein) can be performed, in whole or in part, by the computing-device architecture 1000 shown in FIG. 10. For instance, a computing device with the computing-device architecture 1000 shown in FIG. 10 can include, or be included in, the components of the occlusion determiner 104, system 200, and/or system 500 and can implement the operations of process 700, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 700, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

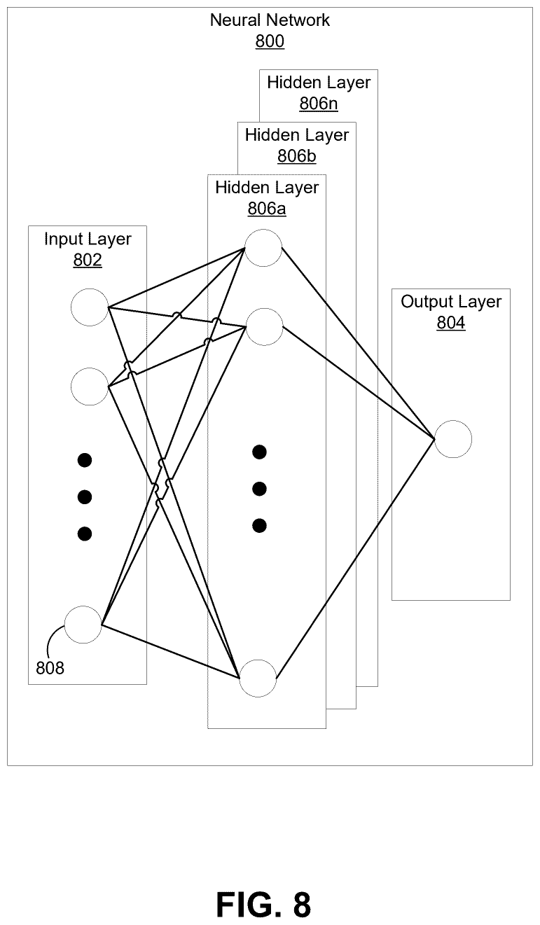

FIG. 8 is an illustrative example of a neural network 800 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 800 may be an example of, or can implement, object detector(s) 204 and/or segmenter 212 of FIG. 2 and/or segment classifier 506, encoder 514, and/or encoder 526 of FIG. 5.

An input layer 802 includes input data. In one illustrative example, input layer 802 can include data representing image 202 and/or image patch 208 of FIG. 2, and/or segments 504, image patch 502, masked image patch 512, and/or object class 524 of FIG. 5. Neural network 800 includes multiple hidden layers, for example, hidden layers 806a, 806b, through 806n. The hidden layers 806a, 806b, through hidden layer 806n include “n” number of hidden layers, where “n” is an integer greater than or equal to one. The number of hidden layers can be made to include as many layers as needed for the given application. Neural network 800 further includes an output layer 804 that provides an output resulting from the processing performed by the hidden layers 806a, 806b, through 806n. In one illustrative example, output layer 804 can generate bounding box 206, image patch 208, object class 210, and/or segments 214 of FIG. 2 and/or occluding segments 508, features 516, features 518, and/or features 528 of FIG. 5.

Neural network 800 may be, or may include, a multi-layer neural network of interconnected nodes. Each node can represent a piece of information. Information associated with the nodes is shared among the different layers and each layer retains information as information is processed. In some cases, neural network 800 can include a feed-forward network, in which case there are no feedback connections where outputs of the network are fed back into itself. In some cases, neural network 800 can include a recurrent neural network, which can have loops that allow information to be carried across nodes while reading in input.

Information can be exchanged between nodes through node-to-node interconnections between the various layers. Nodes of input layer 802 can activate a set of nodes in the first hidden layer 806a. For example, as shown, each of the input nodes of input layer 802 is connected to each of the nodes of the first hidden layer 806a. The nodes of first hidden layer 806a can transform the information of each input node by applying activation functions to the input node information. The information derived from the transformation can then be passed to and can activate the nodes of the next hidden layer 806b, which can perform their own designated functions. Example functions include convolutional, up-sampling, data transformation, and/or any other suitable functions. The output of the hidden layer 806b can then activate nodes of the next hidden layer, and so on. The output of the last hidden layer 806n can activate one or more nodes of the output layer 804, at which an output is provided. In some cases, while nodes (e.g., node 808) in neural network 800 are shown as having multiple output lines, a node has a single output and all lines shown as being output from a node represent the same output value.

In some cases, each node or interconnection between nodes can have a weight that is a set of parameters derived from the training of neural network 800. Once neural network 800 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 800 to be adaptive to inputs and able to learn as more and more data is processed.

Neural network 800 may be pre-trained to process the features from the data in the input layer 802 using the different hidden layers 806a, 806b, through 806n in order to provide the output through the output layer 804. In an example in which neural network 800 is used to identify features in images, neural network 800 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 800 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 800 is trained well enough so that the weights of the layers are accurately tuned.

For the example of identifying objects in images, the forward pass can include passing a training image through neural network 800. The weights are initially randomized before neural network 800 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 800, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 800 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 800 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 800 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 800 can include any other deep network other than a CNN, such as an autoencoder, a deep belief nets (DBNs), a Recurrent Neural Networks (RNNs), among others.

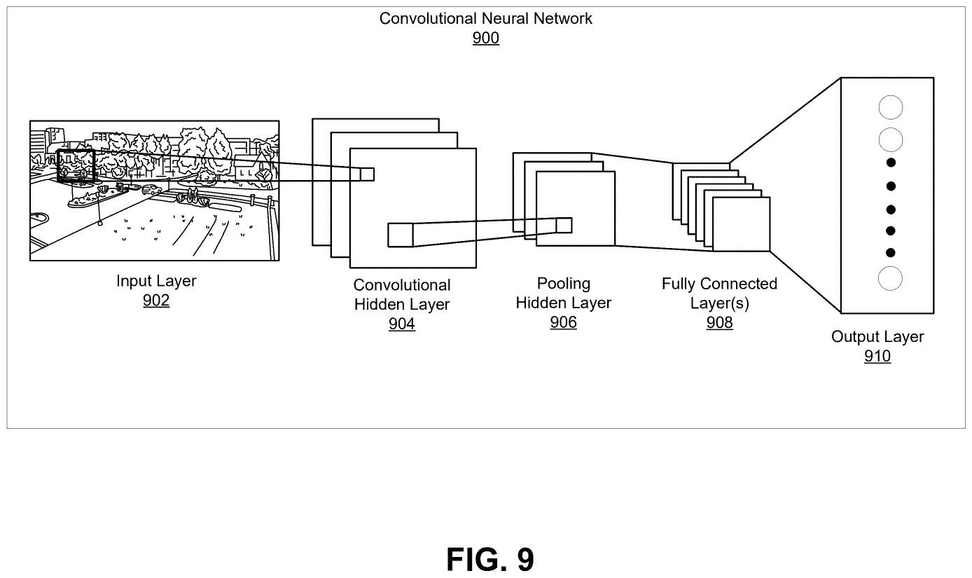

FIG. 9 is an illustrative example of a convolutional neural network (CNN) 900. The input layer 902 of the CNN 900 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 904, an optional non-linear activation layer, a pooling hidden layer 906, and fully connected layer 908 (which fully connected layer 908 can be hidden) to get an output at the output layer 910. While only one of each hidden layer is shown in FIG. 9, one of ordinary skill will appreciate that multiple convolutional hidden layers, non-linear layers, pooling hidden layers, and/or fully connected layers can be included in the CNN 900. As previously described, the output can indicate a single class of an object or can include a probability of classes that best describe the object in the image.

The first layer of the CNN 900 can be the convolutional hidden layer 904. The convolutional hidden layer 904 can analyze image data of the input layer 902. Each node of the convolutional hidden layer 904 is connected to a region of nodes (pixels) of the input image called a receptive field. The convolutional hidden layer 904 can be considered as one or more filters (each filter corresponding to a different activation or feature map), with each convolutional iteration of a filter being a node or neuron of the convolutional hidden layer 904. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 904. Each connection between a node and a receptive field for that node learns a weight and, in some cases, an overall bias such that each node learns to analyze its particular local receptive field in the input image. Each node of the convolutional hidden layer 904 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 904 is due to each node of the convolutional layer being applied to its corresponding receptive field. For example, a filter of the convolutional hidden layer 904 can begin in the top-left corner of the input image array and can convolve around the input image. As noted above, each convolutional iteration of the filter can be considered a node or neuron of the convolutional hidden layer 904. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 904. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 904.

The mapping from the input layer to the convolutional hidden layer 904 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 904 can include several activation maps in order to identify multiple features in an image. The example shown in FIG. 9 includes three activation maps. Using three activation maps, the convolutional hidden layer 904 can detect three different kinds of features, with each feature being detectable across the entire image.

In some examples, a non-linear hidden layer can be applied after the convolutional hidden layer 904. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 900 without affecting the receptive fields of the convolutional hidden layer 904.

The pooling hidden layer 906 can be applied after the convolutional hidden layer 904 (and after the non-linear hidden layer when used). The pooling hidden layer 906 is used to simplify the information in the output from the convolutional hidden layer 904. For example, the pooling hidden layer 906 can take each activation map output from the convolutional hidden layer 904 and generates a condensed activation map (or feature map) using a pooling function. Max-pooling is one example of a function performed by a pooling hidden layer. Other forms of pooling functions be used by the pooling hidden layer 906, such as average pooling, L2-norm pooling, or other suitable pooling functions. A pooling function (e.g., a max-pooling filter, an L2-norm filter, or other suitable pooling filter) is applied to each activation map included in the convolutional hidden layer 904. In the example shown in FIG. 9, three pooling filters are used for the three activation maps in the convolutional hidden layer 904.

In some examples, max-pooling can be used by applying a max-pooling filter (e.g., having a size of 2×2) with a stride (e.g., equal to a dimension of the filter, such as a stride of 2) to an activation map output from the convolutional hidden layer 904. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 904 having a dimension of 24×24 nodes, the output from the pooling hidden layer 906 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 900.

The final layer of connections in the network is a fully-connected layer that connects every node from the pooling hidden layer 906 to every one of the output nodes in the output layer 910. Using the example above, the input layer includes 28×28 nodes encoding the pixel intensities of the input image, the convolutional hidden layer 904 includes 3×24×24 hidden feature nodes based on application of a 5×5 local receptive field (for the filters) to three activation maps, and the pooling hidden layer 906 includes a layer of 3×12×12 hidden feature nodes based on application of max-pooling filter to 2×2 regions across each of the three feature maps. Extending this example, the output layer 910 can include ten output nodes. In such an example, every node of the 3×12×12 pooling hidden layer 906 is connected to every node of the output layer 910.

The fully connected layer 908 can obtain the output of the previous pooling hidden layer 906 (which should represent the activation maps of high-level features) and determines the features that most correlate to a particular class. For example, the fully connected layer 908 can determine the high-level features that most strongly correlate to a particular class and can include weights (nodes) for the high-level features. A product can be computed between the weights of the fully connected layer 908 and the pooling hidden layer 906 to obtain probabilities for the different classes. For example, if the CNN 900 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 910 can include an M-dimensional vector (in the prior example, M=10). M indicates the number of classes that the CNN 900 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 10 illustrates an example computing-device architecture 1000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1000 may include, implement, or be included in any or all of occlusion determiner 104 of FIG. 1, system 200 of FIG. 2, system 500 of FIG. 5 and/or other devices, modules, or systems described herein. Additionally or alternatively, computing-device architecture 1000 may be configured to perform process 700, and/or other process described herein.

The components of computing-device architecture 1000 are shown in electrical communication with each other using connection 1012, such as a bus. The example computing-device architecture 1000 includes a processing unit (CPU or processor) 1002 and computing device connection 1012 that couples various computing device components including computing device memory 1010, such as read only memory (ROM) 1008 and random-access memory (RAM) 1006, to processor 1002.

Computing-device architecture 1000 can include a cache of high-speed memory connected directly with, in close proximity to, or integrated as part of processor 1002. Computing-device architecture 1000 can copy data from memory 1010 and/or the storage device 1014 to cache 1004 for quick access by processor 1002. In this way, the cache can provide a performance boost that avoids processor 1002 delays while waiting for data. These and other modules can control or be configured to control processor 1002 to perform various actions. Other computing device memory 1010 may be available for use as well. Memory 1010 can include multiple different types of memory with different performance characteristics. Processor 1002 can include any general-purpose processor and a hardware or software service, such as service 1 1016, service 2 1018, and service 3 1020 stored in storage device 1014, configured to control processor 1002 as well as a special-purpose processor where software instructions are incorporated into the processor design. Processor 1002 may be a self-contained system, containing multiple cores or processors, a bus, memory controller, cache, etc. A multi-core processor may be symmetric or asymmetric.

To enable user interaction with the computing-device architecture 1000, input device 1022 can represent any number of input mechanisms, such as a microphone for speech, a touch-sensitive screen for gesture or graphical input, keyboard, mouse, motion input, speech and so forth. Output device 1024 can also be one or more of a number of output mechanisms known to those of skill in the art, such as a display, projector, television, speaker device, etc. In some instances, multimodal computing devices can enable a user to provide multiple types of input to communicate with computing-device architecture 1000. Communication interface 1026 can generally govern and manage the user input and computing device output. There is no restriction on operating on any particular hardware arrangement and therefore the basic features here may easily be substituted for improved hardware or firmware arrangements as they are developed.

Storage device 1014 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1006, read only memory (ROM) 1008, and hybrids thereof. Storage device 1014 can include services 1016, 1018, and 1020 for controlling processor 1002. Other hardware or software modules are contemplated. Storage device 1014 can be connected to the computing device connection 1012. In one aspect, a hardware module that performs a particular function can include the software component stored in a computer-readable medium in connection with the necessary hardware components, such as processor 1002, connection 1012, output device 1024, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for detecting occlusions, the apparatus comprising: at least one memory; and at least one processor coupled to the at least one memory and configured to: detect an object in an image; determine a bounding box based on the object in the image; determine an image patch of the image based on the bounding box; segment the image patch into a plurality of segments; and determine that the object is at least partially occluded in the image based on the bounding box and the plurality of segments.

Aspect 2. The apparatus of aspect 1, wherein the at least one processor is configured to identify at least one object segment from among the plurality of segments, wherein the at least one object segment relates to the object detected in the image, wherein the determination that the object is at least partially occluded in the image is based on a relationship between an area of the at least one object segment and an area of the bounding box.

Aspect 3. The apparatus of aspect 2, wherein the at least one processor is configured to: classify the object to obtain an object class; determine a threshold based on the object class; and determine that the object is at least partially occluded in the image based on a value associated with a comparison between the area of the at least one object segment and the area of the bounding box being below the threshold.

Aspect 4. The apparatus of any one of aspects 1 to 3, wherein the at least one processor is configured to identify at least one occluding segment from among the plurality of segments, wherein the at least one occluding segment relates to an object that occludes a view of the object detected in the image, wherein the determination that the object is at least partially occluded in the image is based on the at least one occluding segment and the bounding box.

Aspect 5. The apparatus of aspect 4, wherein an occluding segment of the at least one occluding segment is identified based on a determination that a portion of the occluding segment intersects at least one boundary of the bounding box.

Aspect 6. The apparatus of any one of aspects 1 to 5, wherein the at least one processor is configured to: process the image patch using an image encoder to generate first image features; identify at least one occluding segment from among the plurality of segments; mask the at least one occluding segment in the image patch to generate a masked image patch; and process the masked image patch using the image encoder to generate second image features; wherein the determination that the object is at least partially occluded in the image is based on a comparison between the first image features and the second image features.

Aspect 7. The apparatus of aspect 6, wherein the at least one processor is configured to: classify the object to obtain an object class; and process the object class using an encoder to generate class features; wherein the determination that the object is at least partially occluded in the image is based on the class features, the first image features and the second image features.

Aspect 8. The apparatus of any one of aspects 1 to 7, wherein the apparatus comprises a computing system of a vehicle.

Aspect 9. The apparatus of aspect 8, wherein the at least one processor is configured to adjust an operating parameter of the vehicle based on the determination that the object is at least partially occluded.

Aspect 10. The apparatus of aspect 9, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the determination that the object is at least partially occluded using a user interface of the vehicle.

Aspect 11. A method for detecting occlusions, the method comprising: detecting an object in an image; determining a bounding box based on the object in the image; determining an image patch of the image based on the bounding box; segmenting the image patch into a plurality of segments; and determining that the object is at least partially occluded in the image based on the bounding box and the plurality of segments.

Aspect 12. The method of aspect 11, further comprising identifying at least one object segment from among the plurality of segments, wherein the at least one object segment relates to the object detected in the image, wherein the determination that the object is at least partially occluded in the image is based on a relationship between an area of the at least one object segment and an area of the bounding box.

Aspect 13. The method of aspect 12, further comprising: classifying the object to obtain an object class; determining a threshold based on the object class; and determining that the object is at least partially occluded in the image based on a value associated with a comparison between the area of the at least one object segment and the area of the bounding box being below the threshold.

Aspect 14. The method of any one of aspects 11 to 13, further comprising identifying at least one occluding segment from among the plurality of segments, wherein the at least one occluding segment relates to an object that occludes a view of the object detected in the image, wherein the determination that the object is at least partially occluded in the image is based on the at least one occluding segment and the bounding box.

Aspect 15. The method of aspect 14, wherein an occluding segment of the at least one occluding segment is identified based on a determination that a portion of the occluding segment intersects at least one boundary of the bounding box.

Aspect 16. The method of any one of aspects 11 to 15, further comprising: processing the image patch using an image encoder to generate first image features; identifying at least one occluding segment from among the plurality of segments; masking the at least one occluding segment in the image patch to generate a masked image patch; and processing the masked image patch using the image encoder to generate second image features; wherein the determination that the object is at least partially occluded in the image is based on a comparison between the first image features and the second image features.

Aspect 17. The method of aspect 16, further comprising: classifying the object to obtain an object class; and processing the object class using an encoder to generate class features; wherein the determination that the object is at least partially occluded in the image is based on the class features, the first image features and the second image features.

Aspect 18. The method of any one of aspects 11 to 17, further comprising adjusting an operating parameter of a vehicle based on the determination that the object is at least partially occluded.

Aspect 19. The method of aspect 18, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the determination that the object is at least partially occluded using a user interface of the vehicle.

Aspect 20. A non-transitory computer-readable storage medium having stored thereon instructions that, when executed by at least one processor, cause the at least one processor to: detect an object in an image; determine a bounding box based on the object in the image; determine an image patch of the image based on the bounding box; segment the image patch into a plurality of segments; and determine that the object is at least partially occluded in the image based on the bounding box and the plurality of segments.

Aspect 21. A non-transitory computer-readable storage medium having stored thereon instructions that, when executed by at least one processor, cause the at least one processor to perform operations according to any of aspects 11 to 20.

Aspect 22. An apparatus for detecting occlusions, the apparatus comprising one or more means for perform operations according to any of aspects 11 to 20.

What is claimed is:

1. An apparatus for detecting occlusions, the apparatus comprising:
at least one memory; and
at least one processor coupled to the at least one memory and configured to:
detect an object in an image;
determine a bounding box based on the object in the image;
determine an image patch of the image based on the bounding box;
segment the image patch into a plurality of segments; and
determine that the object is at least partially occluded in the image based on the bounding box and the plurality of segments.

2. The apparatus of claim 1, wherein the at least one processor is configured to identify at least one object segment from among the plurality of segments, wherein the at least one object segment relates to the object detected in the image, wherein the determination that the object is at least partially occluded in the image is based on a relationship between an area of the at least one object segment and an area of the bounding box.

3. The apparatus of claim 2, wherein the at least one processor is configured to:
classify the object to obtain an object class;
determine a threshold based on the object class; and
determine that the object is at least partially occluded in the image based on a value associated with a comparison between the area of the at least one object segment and the area of the bounding box being below the threshold.

4. The apparatus of claim 1, wherein the at least one processor is configured to identify at least one occluding segment from among the plurality of segments, wherein the at least one occluding segment relates to an object that occludes the object detected in the image, wherein the determination that the object is at least partially occluded in the image is based on the at least one occluding segment and the bounding box.

5. The apparatus of claim 4, wherein an occluding segment of the at least one occluding segment is identified based on a determination that a portion of the occluding segment intersects at least one boundary of the bounding box.

6. The apparatus of claim 1, wherein the at least one processor is configured to:
process the image patch using an image encoder to generate first image features;
identify at least one occluding segment from among the plurality of segments;
mask the at least one occluding segment in the image patch to generate a masked image patch; and
process the masked image patch using the image encoder to generate second image features;
wherein the determination that the object is at least partially occluded in the image is based on a comparison between the first image features and the second image features.

7. The apparatus of claim 6, wherein the at least one processor is configured to:
classify the object to obtain an object class; and
process the object class using an encoder to generate class features;
wherein the determination that the object is at least partially occluded in the image is based on the class features, the first image features and the second image features.

8. The apparatus of claim 1, wherein the apparatus comprises a computing system of a vehicle.

9. The apparatus of claim 8, wherein the at least one processor is configured to adjust an operating parameter of the vehicle based on the determination that the object is at least partially occluded.

10. The apparatus of claim 9, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the determination that the object is at least partially occluded using a user interface of the vehicle.

11. A method for detecting occlusions, the method comprising:
detecting an object in an image;
determining a bounding box based on the object in the image;
determining an image patch of the image based on the bounding box;
segmenting the image patch into a plurality of segments; and
determining that the object is at least partially occluded in the image based on the bounding box and the plurality of segments.

12. The method of claim 11, further comprising identifying at least one object segment from among the plurality of segments, wherein the at least one object segment relates to the object detected in the image, wherein the determination that the object is at least partially occluded in the image is based on a relationship between an area of the at least one object segment and an area of the bounding box.

13. The method of claim 12, further comprising:
classifying the object to obtain an object class;
determining a threshold based on the object class; and
determining that the object is at least partially occluded in the image based on a value associated with a comparison between the area of the at least one object segment and the area of the bounding box being below the threshold.

14. The method of claim 11, further comprising identifying at least one occluding segment from among the plurality of segments, wherein the at least one occluding segment relates to an object that occludes the object detected in the image, wherein the determination that the object is at least partially occluded in the image is based on the at least one occluding segment and the bounding box.

15. The method of claim 14, wherein an occluding segment of the at least one occluding segment is identified based on a determination that a portion of the occluding segment intersects at least one boundary of the bounding box.

16. The method of claim 11, further comprising:
processing the image patch using an image encoder to generate first image features;
identifying at least one occluding segment from among the plurality of segments;
masking the at least one occluding segment in the image patch to generate a masked image patch; and
processing the masked image patch using the image encoder to generate second image features;
wherein the determination that the object is at least partially occluded in the image is based on a comparison between the first image features and the second image features.

17. The method of claim 16, further comprising:
classifying the object to obtain an object class; and
processing the object class using an encoder to generate class features;
wherein the determination that the object is at least partially occluded in the image is based on the class features, the first image features and the second image features.

18. The method of claim 11, further comprising adjusting an operating parameter of a vehicle based on the determination that the object is at least partially occluded.

19. The method of claim 18, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the determination that the object is at least partially occluded using a user interface of the vehicle.

20. A non-transitory computer-readable storage medium having stored thereon instructions that, when executed by at least one processor, cause the at least one processor to:
detect an object in an image;
determine a bounding box based on the object in the image;
determine an image patch of the image based on the bounding box;
segment the image patch into a plurality of segments; and
determine that the object is at least partially occluded in the image based on the bounding box and the plurality of segments.
